(19) United States
(12) Patent Application Publication
(10) Pub. No.: US 2009/0114042 A1
(43) Pub. Date: May 7, 2009

(54) Liquid delivery apparatus

(75) Inventor: Arne Deggerdal, Lysaker (NO)

Correspondence Address: KNOBBE MARTENS OLSON & BEAR LLP, 2040 MAIN STREET, FOURTEENTH FLOOR, IRVINE, CA, 92614, US

(73) Assignee: Mole Genetics AS, Lysaker (NO)

(21) Appl. No.: 12/204,704

(22) Filed: Sep. 4, 2008

(30) Foreign Application Priority Data
Sep. 7, 2007 (GB) 0717459.2

(51) Int. Cl. G01N 1/14

(52) U.S. Cl. 73/863.01; 73/864.14

(57) ABSTRACT

Provided is a pipette head assembly for use in an automated liquid handling device, which assembly comprises a pipette head holder for mounting in the device and a pipette head for locating in the holder, which comprises one or more pipette barrels and associated plungers, wherein the pipette head further comprises a shaped member, the configuration of which uniquely identifies the pipette head, and the holder includes an array of sensors positioned to cooperate with the shaped member when the pipette head is located in the holder so as to detect the configuration of the shaped member for identification of the pipette head by the device.

The present invention relates to a pipette head assembly for use in an automated liquid handling device, a pipette head therefor and an automated liquid handling device comprising such a pipette head assembly.

Automated liquid handling devices are commonly used in laboratories. In molecular biology, for example, nucleic acid separation processes may be operated in an automated device often using magnetic particles as a means to separate the nucleic acid from contaminating material. Devices are commercially available which may include an automated pipette head assembly movable within the device so that it may be aligned with test tubes or vials for reagent liquid handling. Apparatus of this type has been made to very high standards of engineering, using high quality durable machinery which may be precision manufactured to ensure that operation of the device is reliable. Usually, devices of this type include a dedicated microcomputer to enable programmable control of the processes which the device must perform. Such devices are generally expensive to purchase and may require specialist service contracts for maintenance.

Using disposable pipette tips, a pipette head assembly has to aspirate and release samples and reagents which are often highly valuable. A standard pipette head typically comprises one or more pipette barrels and associated plungers to achieve plunger driven air displacement pipetting within a specified pipette volume range. Aspiration and release may be performed according to protocols operated by programming the dedicated microcomputer. In order to run different protocols using different volume ranges, different pipette heads may need to be used in the pipette head assembly. Technical personnel using automated liquid handling devices must therefore select the correct pipette head for a given protocol run on the device. To switch between pipetting ranges, devices frequently offer a set of interchangeable pipette heads. Because the samples and reagents are valuable and in order to avoid damage to the apparatus, it is known to provide devices with systems to recognise the identity of the currently attached pipette head. Typically, these systems are complex and involve electronic parts situated in the pipette head. An example of such an arrangement is found in U.S. Pat. No. 5,139,744. According to this arrangement, a system for module identification in a liquid handling device is provided in which each module has a passive electronic identification means such as a microprocessor readable code stored by non-volatile passive means which is provided to a microprocessor along an intelligence pathway.

Complex apparatus of this type is expensive and increasing levels of complexity potentially increase the likelihood of failure.

The present invention addresses the problem of providing a pipette head recognition system.

In a first aspect, the present invention provides a pipette head assembly for use in an automated liquid handling device, which assembly comprises a pipette head holder for mounting in the device and a pipette head for locating in the holder, which comprises one or more pipette barrels and associated plungers, wherein the pipette head further comprises a shaped member, the configuration of which uniquely identifies the pipette head, and the holder includes an array of sensors positioned to cooperate with the shaped member when the pipette head is located in the holder so as to detect the configuration of the shaped member for identification of the pipette head by the device.

According to the present invention, the need for a complex and expensive pipette recognition system is avoided. Instead, a simple, inexpensive recognition system is provided which does not require electronics in the pipette head.

Each sensor in the pipette head holder may be operated by contact with the shaped member. Such contact is preferably physical contact to operate the sensor. Each sensor preferably comprises a switch, more preferably a micro switch. In a preferred arrangement, the switch is operated by physical contact with the shaped member so as to depress it. In an alternative arrangement, each sensor in the pipette head holder comprises an optical sensor. Such an optical sensor typically provides an optical beam which may be interrupted by the shaped member of the pipette head to alter its switch status. Whichever type of sensor is used, no electronics need be provided in the pipette head because these can be provided in the holder or elsewhere in the liquid handling device. Operation of the sensor or switch can simply open or close a circuit. This enables electronics remote from the pipette head to detect the status of the sensor or switch. For example, a remote microcomputer may be appropriately configured through a built-in parallel port or through dedicated hardware, using methods routine in this field.

The shaped member of the pipette head has a configuration which uniquely identifies it. The shaped member must cooperate with the array of sensors in the holder and these sensors are positioned such that when the pipette head is in place, one or more of the sensors is operated. It is preferred that the shaped member comprises one or more projections from the pipette head. The one or more projections may be a plurality of projections or tabs and each one of these projections may cooperate, preferably by contact, with one of the sensors in the array. Alternatively, the projection or tab may be a single element with one or more sections cut out so that a corresponding sensor in the array is not operated where the cut out section would otherwise engage. It is preferred that the array of sensors is a row of sensors because this is a simple arrangement to provide. The array may comprise no more than five sensors, generally no more than four sensors, preferably no more than three sensors, or no more than two sensors. The number of sensors in the array may be varied depending on the total number of different pipette heads to be uniquely identified. The relationship between the number of sensors and the number of recognisable pipette head types is y=2ⁿ−1, where y is the number of recognisable pipette head types and n is the number of sensors. Thus, a system as described in further detail below, which uses only two sensors means that the system can recognise three types of pipette head plus the absence of a pipette head. Thus, to increase the number of pipette heads that can be recognised, the number of sensors must be increased.

In a further aspect, the present invention provides a pipette head for use in a pipette head assembly as described herein. The pipette head comprises one or more pipette barrels and associated plungers and further comprises a shaped member, the configuration of which uniquely identifies the pipette head. A pipette head system may also be provided, which comprises a plurality of different pipette heads, each capable of pipetting within a unique volume range, the volume range uniquely identified by a configuration of the shaped member. An automated liquid handling device which comprises the pipette head assembly is also provided.

The present invention will now be described in further detail, by way of example only, with reference to the accompanying drawings, in which:

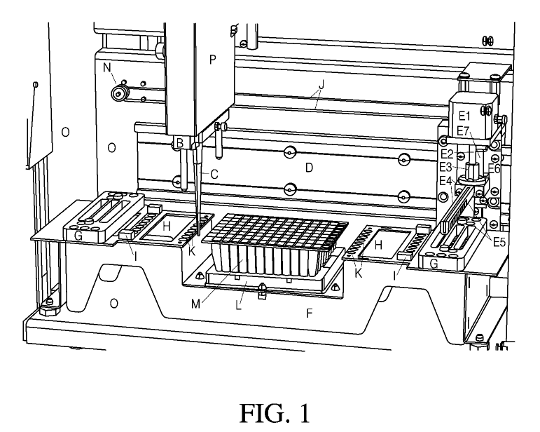

FIG. 1 shows a perspective view of an automated liquid handling device according to the present invention;

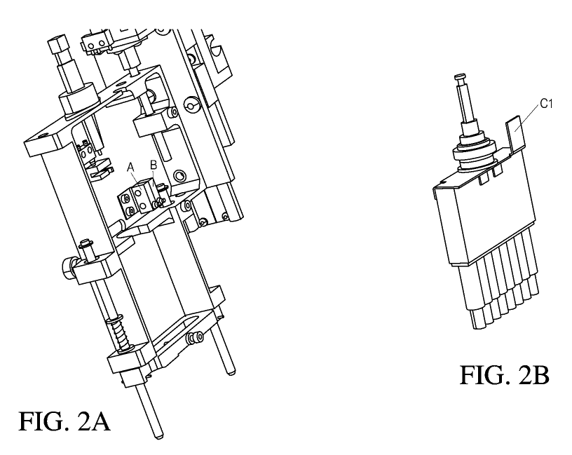

FIG. 2 shows a perspective view of (a) a pipette head holder and (b) a pipette head according to the invention; and

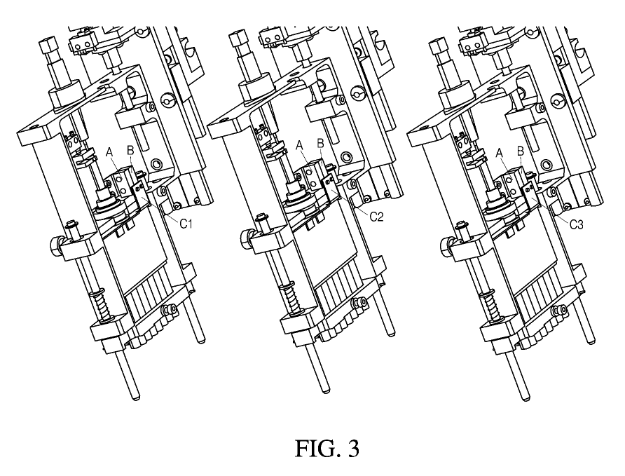

FIG. 3 shows a perspective view of three pipette head assemblies each according to the invention.

FIG. 1 shows the principal features of a liquid delivery apparatus according to a specific embodiment of the invention. Instrument frame O generally forms part of a cabinet for laboratory bench top use. Work surface tray F is made of stainless steel and provides a surface for mounting or positioning various other elements of the apparatus. Pipette storage plate G enables storage of pipette tips. A holder for elution tubes I is provided adjacent the pipette tip storage plate. A waste box position H enables waste to be disposably located therein. Positions for sample tubes K are provided adjacent the waste box position. A series of reagent strips M are seated on base plate L. The base plate is positioned on the work surface tray by means of protruding cones. Further positions for sample tubes K, holder for elution tubes I and pipette tip storage plate G are provided.

Pipette head assembly P is movable horizontally and vertically. Horizontal movement is achieved by attachment of the assembly to rails along the back wall of the apparatus frame and the assembly is driven by a drive belt powered by a motor (not shown). Vertical movement is achieved by mounting the head on a threaded axle which is driven by a further motor. A pipette tip ejector is provided on the pipette head and the head is shown in the Figure with a single disposable pipette tip. The pipette head may attach a plurality of disposable pipette tips. The pipette head recognition system is not visible in this Figure.

The magnetic rod E4 comprises a standard aluminium rod to which are secured magnets E5. The magnets are seated in holes in the aluminium rod and are attached to a flat steel rod (not shown) which sits in a groove in the aluminium rod. Module carriage E6 provides a mounting for magnetic rod E4 and motor E1. At the end of the magnetic rod proximal to the module carriage E6 is provided a small carriage part slidably mounted on vertical rail E7. Motor E1 drives threaded axle E2, which passes through nut E3 fixed to the small carriage part of the magnetic rod to provide vertical movement on the vertical rail E7. Module carriage E6 is mounted for horizontal movement along the horizontal rail to enable the entire assembly including magnetic rod E4 and motor E1 to move horizontally. Drive belt J turns over a free pulley N on one side and over a pulley fixed to the axle of the motor on the other side (not shown) to provide horizontal movement along the rail.

FIG. 2(a) shows a perspective view of a pipette head holder without any pipette head attached. Micro switches A and B are provided at a position above where the body of the pipette head will be located. FIG. 2(b) shows a perspective view of a pipette head of volume range 1 (“type 1”) with tab C positioned to cooperate with the micro switches A and B once the pipette head is in place in the pipette head holder. Tab C is designated C1 to signify that this is the tab that identifies the pipette head as type 1.

The pipette head of the instrument is interchangeable. Pipette heads designed for different volume ranges can be attached to the pipette head holder of the instrument in order to enable the instrument to recognise the kind of pipette head that is attached to it. The pipette heads are supplied with steel tabs C of different shapes. As shown in FIG. 2, the tab of a pipette head with the volume range 1 will depress two micro switches (A and B) which are connected to the main circuit board of the instrument. The tabs of pipettes with volume ranges 2 or 3 are somewhat smaller. These tabs will depress only micro switch A or B respectively. Registering which, if any, of the switches A and B are depressed, the instrument can recognise the type of pipette head which is attached. If none of the micro switches are depressed, the instrument will register the absence of a pipette head.

This is illustrated further in FIG. 3, which shows in perspective view the three possible pipette head types each in place in a pipette head holder. According to the left hand Figure the tab of pipette type I (C1) depresses both micro switch A and B. In the middle Figure, the tab of pipette type 2 depresses only micro switch A. In the right hand Figure, the tab of pipette type 3 depresses only micro switch B.

1. A pipette head assembly for use in an automated liquid handling device, which assembly comprises a pipette head holder for mounting in the device and a pipette head for locating in the holder, which comprises one or more pipette barrels and associated plungers, wherein the pipette head further comprises a shaped member, the configuration of which uniquely identifies the pipette head, and the holder includes an array of sensors positioned to cooperate with the shaped member when the pipette head is located in the holder so as to detect the configuration of the shaped member for identification of the pipette head by the device.

2. A pipette head assembly according to claim 1, wherein the shaped member of the pipette head comprises one or more projections therefrom.

3. A pipette head assembly according to claim 1, wherein each sensor comprises a switch.

4. A pipette head assembly according to claim 3, wherein the switch is a micro switch.

5. A pipette head assembly according to claim 1, wherein each sensor is operated by contact with the shaped member.

6. A pipette head assembly according to claim 1, wherein the array of sensors is a row of sensors.

7. A pipette head assembly according to claim 1, wherein the array of sensors comprises no more than 5 sensors.

8. A pipette head for use in a pipette assembly according to claim 1, which comprises one or more pipette barrels and associated plungers and further comprises a shaped member, the configuration of which uniquely identifies the pipette head.

9. An automated liquid handling device which comprises a pipette head assembly according to claim 1.
